(19) United States
(12) Patent Application Publication
(10) Pub. No.: US 2011/0093387 A1
(43) Pub. Date: Apr. 21, 2011

(54) SYSTEM AND METHOD FOR NON-CREDIT CARD BILLERS TO ACCEPT CREDIT CARD PAYMENTS

(76) Inventors: Zack Fuerstenberg, Toronto (CA); Thomas Purves, Toronto (CA); Gordon McCalden, Mississauga (CA); Brian Weiner, Thornhill (CA)

(21) Appl. No.: 12/904,503

(22) Filed: Oct. 14, 2010

Related U.S. Application Data
(60) Provisional application No. 61/252,598, filed on Oct. 16, 2009.

(51) Int. Cl. G06Q 40/00

(52) U.S. Cl. 705/40

(57) ABSTRACT

One embodiment of the invention is directed to a method comprising, receiving a payment request message that includes information related to a user and a biller, determining whether the user is enrolled in a bill pay program, and if the user is enrolled in the bill pay program, modifying the payment request message according to user preferences if the user preferences are different than the information in the payment request message. The method further comprises, receiving a payment response message, and generating, using a server computer, transaction information based on the payment response message and biller information, wherein the transaction information is combined with existing reporting and billing process information for the biller.

### CROSS-REFERENCES TO RELATED APPLICATIONS

This application is a non-provisional application and claims priority to U.S. Provisional Application No. 61/252,598, filed on Oct. 16, 2009, the entire contents of which are herein incorporated by reference.

### BACKGROUND

For many traditional bill payment merchants, such as regional utilities, accepting payment via payment cards (e.g., credit cards) can be prohibitively challenging due to costs and organization effort required to integrate payments via payment cards with existing payment processing methods.

Embodiments of the invention address these and other problems individually and collectively.

### BRIEF SUMMARY

Embodiments of the invention are directed to systems, apparatuses and methods to allow bill payment merchants to accept payment card payments.

One embodiment of the invention is directed to a method comprising, receiving a payment request message that includes information related to a user and a biller, determining whether the user is enrolled in a bill pay program, and if the user is enrolled in the bill pay program, modifying the payment request message according to user preferences if the user preferences are different than the information in the payment request message. The method further comprises, receiving a payment response message, and generating, using a server computer, transaction information based on the payment response message and biller information, wherein the transaction information is combined with existing reporting and billing process information for the biller.

Another embodiment of the invention is directed to a method comprising, providing, using a computer apparatus, user information, and providing preferences related to bill payment wherein the user information and preferences related to bill payment can be utilized to pay bills from different merchants.

Other embodiments are directed to computer readable media comprising code for performing the above-described methods as well as systems, apparatuses and devices that perform the methods and/or that use the computer readable media.

These and other embodiments of the invention are described in further detail below.

### BRIEF DESCRIPTION OF THE DRAWINGS

FIG. 1 shows a block diagram of system and process flows according to embodiments of the invention.

FIG. 2 shows a block diagram exemplary computer apparatus.

FIG. 3 shows a flowchart illustrating steps in a method according to an embodiment of the invention.

FIGS. 4-9 show exemplary user interface screens according to embodiments of the invention.

FIG. 10 shows components related to value-added merchant-facing features according to embodiments of the invention.

### DETAILED DESCRIPTION

Embodiments of the invention are directed to systems, apparatuses, and methods for “turnkey” payment card acceptance for bill payment merchants that already receive non-payment card, electronic payments through a merchant processor or bill payment aggregator. The systems and methods are related to various types of payments, including recurring payments, bill pay payments, ecommerce, and mail order and telephone order payments (“moto”) (e.g., Visa recurring payments, Visa bill pay payments, and Visa ecommerce and moto payments).

Enabling “turnkey” acceptance of payment cards for payments by integrating payment card acceptance processing platforms with traditional ACH bill payment item processing channels can deliver operational efficiencies for bill payment merchants and open new acceptance segments for payment cards, resulting increased volumes and revenue.

For example, embodiments of the invention allow a bill payment merchant to enroll in a bill payment system so that the bill payment merchant can accept payment cards with minimal implementation on the merchant's part. Instead of a cumbersome and costly technical implementation to add functionality to accept credit cards (e.g., adding shopping cart functionality on its website, storage and security involved in storing customer information, etc.), the merchant simply has to add a link or button on its website for its customers to click on and be re-directed to the bill payment system. Thereafter, the merchant's customers can enroll in the bill payment system and set up payment options to pay bills from the merchant (e.g., one time payment, recurring payments, etc.). The bill payment system gives the merchant and its customers a number of features for bill payment and management, as described in further detail below. Payment card payments and reconciliation data may be combined with the bill payment merchants' existing reporting and business processes.

System

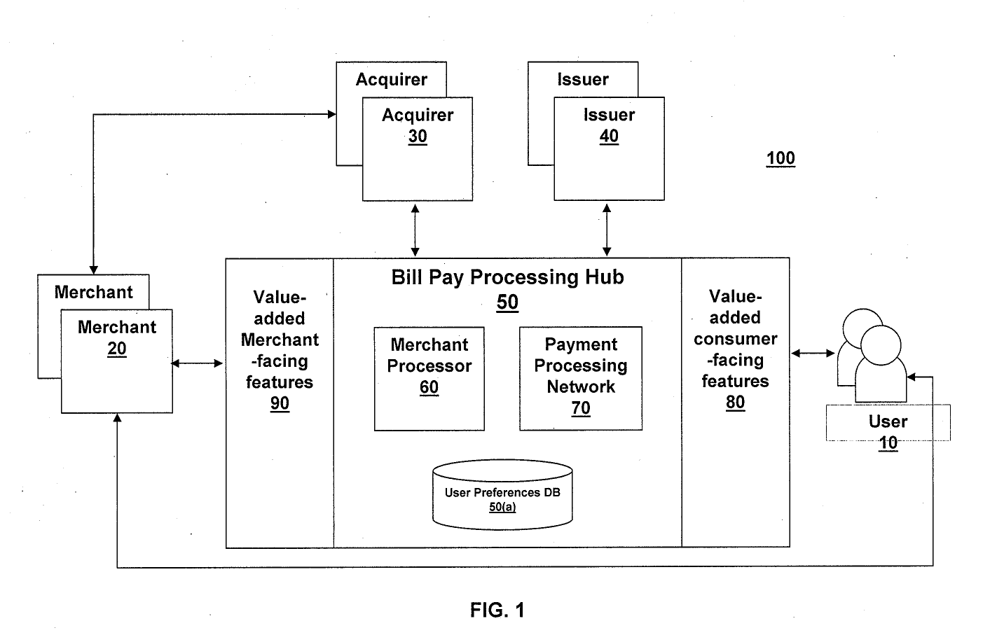

FIG. 1 illustrates a system 100 in accordance with an embodiment of the invention. The system 100 includes a user 10, a merchant 20, an acquirer 30, an issuer 40, and a bill pay processing hub 50, operatively coupled together. Although one user 10, one merchant 20, one acquirer 30, and one issuer 40, are shown, there may be any suitable number of any of these entities in system 100.

User 10 refers to an individual or organization such as a business that is capable of purchasing goods or services, paying bills, or making any suitable payment transaction with merchant 20. User 10 may also be referred to as a consumer, cardholder, or payer throughout this description. User 10 is in operative communication with a portable consumer device (not shown). Merchant 20 may have an access device for interacting with the consumer portable device and acquirer 30 associated with merchant 20. Acquirer 30 is in communication with issuer 40 through payment processing network 70.

Portable consumer device refers to any suitable device that allows the payment transaction to be conducted with merchant. Portable consumer device may be in any suitable form. For example, suitable portable consumer devices can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. In some cases, portable consumer device may be associated with an account of user 10 such as a bank account.

Merchant 20 refers to any suitable entity or entities that make a payment transaction with user 10 (e.g., for purchase of goods/services, payment of bills, etc.). Merchant 20 may use any suitable method to make the payment transaction. For example, merchant 20 may use an e-commerce business to allow the payment transaction to be conducted by merchant 20 and user 10 through the Internet. Other examples of merchant 20 include a department store, a gas station, a drug store, a grocery store, utility company or other suitable business. Merchant 20 may also be referred to as a bill pay merchant, merchant biller, or biller throughout this description. The merchant 20 may operate a server computer, which may have a computer readable medium comprising code for performing the functions that the merchant 20 performs. A database comprising customer billing information and other information may be operatively coupled to the server computer.

Acquirer 30 refers to any suitable entity that has an account with merchant 20. In some embodiments, issuer 40 may also be acquirer 30. An acquirer 30 is typically a bank that has a merchant account. Issuer 40 refers to any suitable entity that may open and maintain an account associated with portable consumer device for user 10. Some examples of issuers may be a bank, a business entity such as a retail store, or a governmental entity. In many cases, issuer 40 may also issue portable consumer device associated with the account to user 10. Some entities are both acquirers and issuers, and embodiments of the invention include such entities. The acquirer 30 or issuer 40 may operate a server computer, which may have a computer readable medium comprising code for performing the functions that the acquirer 30 or issuer 40 performs. A database comprising account number information and other information may be operatively coupled to the server computer.

Payment processing network 70 refers to a network of suitable entities that have information related to an account associated with a portable consumer device (e.g., payment card). This information includes data associated with the account on the portable consumer device such as profile information, data, and other suitable information.

A payment processing network 70 (e.g., Visanet) may operate a server computer, which may have a computer readable medium comprising code for performing the functions that the payment processing organization performs. A database comprising information such as merchant and consumer information (e.g., bill payer information) may be operatively coupled to the server computer. The payment processing network is a secure network area which is typically a private network segment. It may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet. Typically this type of payment processing network is used for secure financial transactions.

The bill pay processing hub 50 may include a merchant processor 60, a payment processing network 70, a user preferences database 50(a), value-added consumer-facing features 80, and value-added merchant-facing features 90.

Merchant processor 60 may be an entity that currently process non-payment card bill payments such as ACH/EFT payment processors or wholesale lockbox payment processors. In embodiments of the invention, the merchant processor 60 may integrate or develop a number of consumer-facing payment card-acceptance and processing capabilities and may integrate these with the existing flow of payment data and reporting that they currently provide to bill pay merchants. Embodiments of the invention allow entities such as a payment processing network 70 to enable a merchant bill pay processors 60 to penetrate unserved or underserved payment card payments acceptance markets. A merchant processor 60 may be a third party entity or may be part of or operated by a payment processing network 70. The merchant processor 60 may also operate a server computer (not shown).

User preferences database 50(a) may include payment options and preferences of the user for use in the bill payment system, as described in further detail below.

Value-added consumer-facing features 80 may include a number of turn-key processing features to facilitate the collection and handling of payment card payments from users 10. Value-added merchant-facing feature 90 may also include a number of turn-key processing features to facilitate the collection and handling of payment card payments from users. Both the consumer-facing and merchant-facing features are described in further detail below.

As noted above, a number of entities (e.g., the merchant 20, the merchant processor 60 and the payment processing network 70, etc.) in FIG. 1 may operate a server computer. As used herein, a “server computer” can typically be a powerful computer or cluster of computers. For example, the server computer can be a large mainframe, a minicomputer cluster, or a group of servers functioning as a unit. In one example, the server computer may be a database server coupled to a web server. The payment processing network may use any suitable wired or wireless network, including the Internet.

Merchant Enrollment and Features

To participate in a bill pay system a merchant 20 may enroll in the system. To enroll in the system a merchant 20 may enter into an agreement with a merchant processor 60 or a payment processing network 70 or extend an existing agreement with a merchant processor 60 or a payment processing network 70.

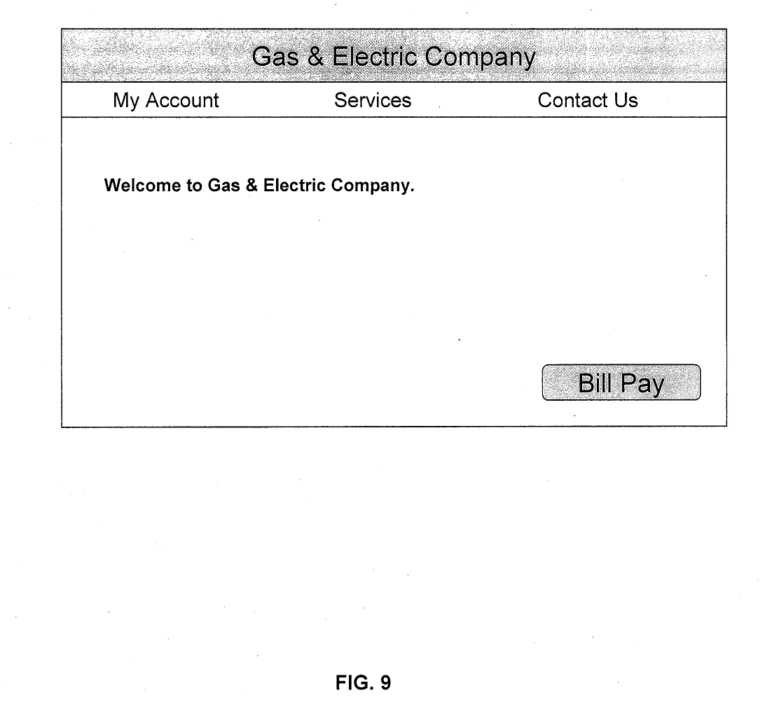

Once the merchant 20 is enrolled in the system, the merchant 20 may include a link on its website that allows a user 10 to enroll in and pay merchant bills with the bill payment system. For example, a merchant 10 may include a “Bill Pay” button on its website as shown in FIG. 9. This makes it very simple for the merchant 10 to implement the bill payment system since including a link or button on its website takes minimal implementation and can be up in running in very little time. A user 10 may then just click the link and be re-directed to the bill pay system without any involvement or further technical implementation from the merchant 10. This enables a low cost solution for the merchant to start accepting payment cards for bill payment since they would not have to build the functionality from scratch which can be very costly (e.g., to implement a shopping cart, provide security for transactions and account information, etc.). Moreover, this may also give the merchant 20 a variety of options and tools to use to make it easier to accept payment cards, as described below. The merchant 20 also has the flexibility to add or remove various features at any time through the bill payment system without any implementation on its part. A fee may be charged to the merchant 20 for these features or the features may be included as part of the standard bill payment system.

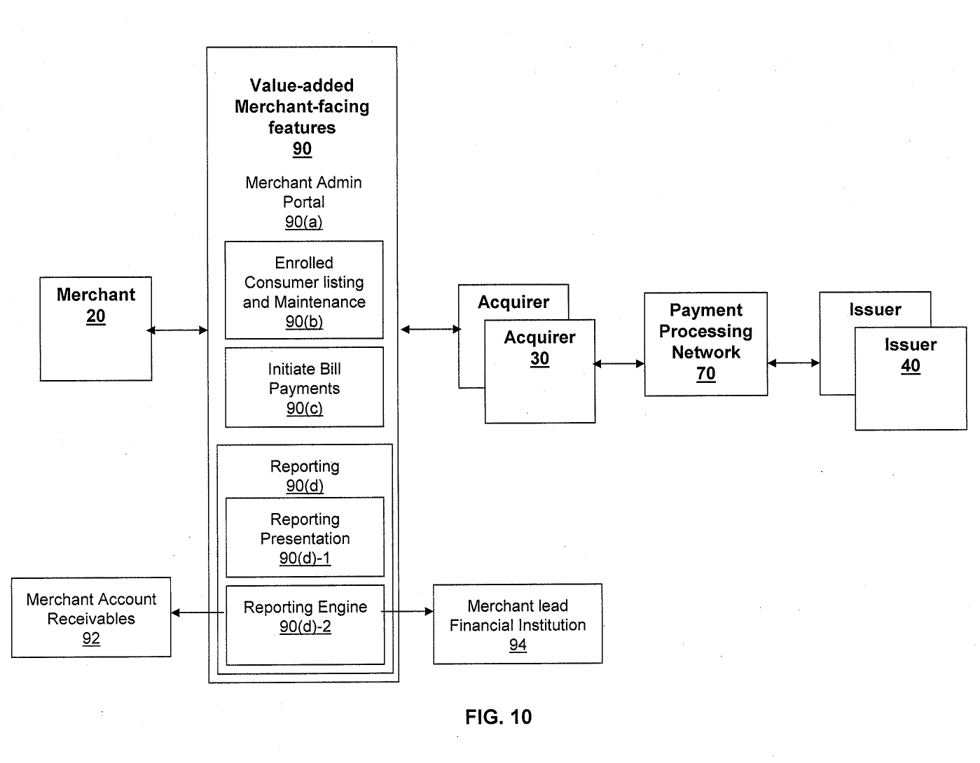

Value-added merchant-facing features 90 may be presented to the merchant in the form of a merchant admin portal 90(a) as shown in FIG. 10. The merchant 20 may access the merchant admin portal 90(a) either manually or in an automated basis to manage the list of enrolled customers, to initiate bill payments and to view reporting.

An enrolled consumer listing and maintenance interface 90(b) may be provided for the merchant 20 to be able to access all of its consumers that have given their information to the merchant 20 for billing. For example, a consumer may enroll through a merchant website or a merchant 10 may have enrolled the consumer via phone or other means (e.g., mail order or telephone order transaction). This interface may be used by the merchant 20 to enter, view, or update consumer information. This gives the merchant 20 visibility into which consumers have signed up for payment with them and the ability to add, modify, or delete a customer list that is on file.

A component to initiate bill payments 90(c) may be provided for the merchant 20 to manually or automatically send bills to the acquirer 30. For example, a merchant 20 may log in and manually enter billing information for each customer (e.g., John Smith $40.32, Jane Doe $32.22, etc.) and then submit it manually or a merchant 20 may just send an automated file to the portal that has all the billing information for its customers (e.g., individual files or batch files with all customer billing information).

A reporting 90(d) component may also be provided to provide reporting features for the merchant 20. This way a merchant 20 may find out what transactions went through and what bills it received. The reporting may be received by the merchant account receivables 92. Typical reports may be in the form of one or more batch files on a periodic basis (e.g., hourly, daily, weekly, etc.) and may include customer accounts, amounts paid for each account, and funds that will appear in the merchant bank account. The merchant 20 may use this information to reconcile with its accounting records. The reporting may be in any standard format or format desired by the merchant 20. Reporting may be available online (e.g., through the reporting presentation 90(d)-1 as described below), by email, fax, or other method. A variety of formats may be available for reporting including regional or industry specific formats such as EDI (electronic documents exchange) or H6 (Canadian payments Association rule H6 format) or other preferred custom formats requested by the merchants. Custom formatting of payment reporting may be used to facilitate integrations of card based bill payments with existing or legacy accounts receivables systems or established back-office processes (e.g., custom formats that the merchant 20 have already worked out for other types of payments). For example, the reporting engine 90(d)-2 may take payment card bill payment settlement reports and reformat them in consistent formats for the merchant 20. This is advantageous because it makes adding payment card based bill payments seamless to existing merchant operations so that the merchant 20 does not have to change existing processes. For example, a merchant 20 may receive either online, email, or fax by custom format for ACH payments. Payment card based bill payments may be folded into these formats to be compliant with existing merchant processes.

The platform may also coordinate settlement of funds from the merchant processor 60 or payment processing network 70 settlement bank to the merchant's lead financial institution 94.

As mentioned above, a reporting presentation 90(d)-1 interface may also be provided. Using the reporting presentation 90(d)-1 interface, a merchant 20 may log in and view all reporting. For example, the merchant 20 may view what payments have or have not been settled for a particular time frame (e.g., that day, that week, that month, etc.).

Value-added merchant-facing features 90 may include a number of turn-key processing features to facilitate the collection and handling of payment card payments from users. These features may include secure, PCI-compliant storage of user account information and payment preferences information may be stored on behalf of the merchant. Typically a merchant 20 has to comply with strict security guidelines for storing a user's account information. For example, Visa™ requires merchants to comply with PCI security guidelines that include requirements such as requiring key card access to merchant facilities, etc. It can be very costly for a merchant 20 to comply with these standards. Thus, it is advantageous for a merchant 20 to rely upon the bill pay processing hub 50, the payment processing network 70 or the merchant processor 60 to store and manage this information securely. This is also advantageous for the user 10 to have more secure account information and more confidence about his transactions through the bill pay system and with the merchant.

Other examples of features include embeddable or web-services components enabling bill pay merchants to integrate payment card processing components into the merchant's branded website or preferred bill presentment interface, customer-service screens for the merchant 20 to enter and maintain payment information on behalf of the user (e.g., by telephone customer support representatives (CSRs)), and using a web-based administration service. These service interfaces could be uniquely configured and branded for each specific merchant 20 based on the link from which the user 10 arrives to the hosted interface. Other parameters could be configured for each merchant 20 to support unique risk thresholds, authentication processes (e.g., prompting and matching a utility customer's account number with one held on file by the merchant), and surcharges or fees, if permitted by the jurisdiction or relevant payment card regulations.

This service could also enable the merchant 20 to configure or restrict the acceptance of payment cards to specific situations like expedited or last minute payments, if required by their business model. For example, if a merchant 20 is particularly cost sensitive about how it receives payments, it may only want to receive payment card payment if it is an urgent payment or for late payments. Or the merchant 20 may only want to accept payment cards in its collections department but not for regular bill payment.

Furthermore, the bill pay processing hub 50 (e.g., via merchant processor 60, payment processing network 70) may develop a second processing capability to assist bill pay merchants in integrating payment card bill payments with their existing business processes for handling bill payments. As described above, these business processes would be a part of the services already provided to the merchant 20 by the merchant processor 60 for the handling of automated clearing house (ACH) transactions, electronic funds transfers (EFT), EDI and/or paper items processing. This allows for reports across all payment channels in one report, instead of separate reporting processing for each payment channel. For example, a merchant 20 may receive three or four different streams of payment from users' banks (e.g, checks in the mail, EFT payments, credit card payments, etc.) and then the merchant 20 has to pull these all together and figure out which users have paid their bills and which have not. Embodiments of the invention allow integration of this information into a single report.

The bill pay processing hub 50 (e.g., via merchant processor 60, payment processing network 70) may act as a processing intermediary between the merchant 20 and the merchant's acquiring bank 30 aggregating the payment streams on behalf of the merchant 20. By aggregating bill pay remittances on behalf of the merchant 20, the bill pay processing hub 50 (e.g., via merchant processor 60, payment processing network 70) may enable more efficient handling of receivables by the merchant and a lower cost of integration for accepting payment card bill payments. The bill pay processing hub 50 (e.g., via merchant processor 60, payment processing network 70) may also offer fee-based on-behalf-of (OBO) or outsourced end-customer support services or functions (e.g., call center or chargeback administration) for the merchants that utilize this service to enable them to garner all of the benefits of acceptance and offering consumer choice without having to hire or train their existing support personnel.

The system may be configured to manage all of the fee/markup calculations, billing and reconciliation functions to enable the merchant processor 60 to charge the merchant 20 a specific markup and remit a portion of the collected fees to the payment processing network 70 for provisioning and supporting this service offering.

The payment processing network 70 may also utilize other existing services and assets (such as user directory or targeted marketing) to help make cardholders aware of payment card acceptance by participating users to increase usage and volumes.

Some embodiments of the invention may be implemented outside of the payment processing network's 70 systems and infrastructure, however the resulting payment card payments may flow through the payment processing network 70 in the usual fashion. For example, the merchant processor 60 could be a third-party entity that is separate from the payment processing network 70. In other embodiments of the invention the merchant processor 60 may be part of or operated by the payment processing network 70.

The features described above may be encompassed into a central platform to build a variety of merchant integration options or merchant tools to make it easier for merchant 20 to accept payment cards. These options and tools can be reused across multiple merchants using the bill pay processing hub model.

User Enrollment and Features

In order to use the bill pay system, a user 10 may enroll for the service. There are multiple ways in which the user 10 may become enrolled in the bill pay service. For example, the user 10 may enroll through the bill pay processing hub 50 or may enroll through a payment processing network 70, an issuer 40, a merchant 20, a merchant processor 60, etc. In some embodiments, the user 10 may be enrolled automatically by any of these entities. Enrollment may also be done in a batch mode, by file delivery from these entities or another party. The user 10 may enroll by contacting a customer service representative over the phone (e.g., provided by the bill pay processing hub 50, payment processing network 70, merchant processor 60, etc.), or by accessing a website and filling out an online application. In certain implementations the website may be hosted by one entity but can redirect the user 10 to a site hosted by another entity.

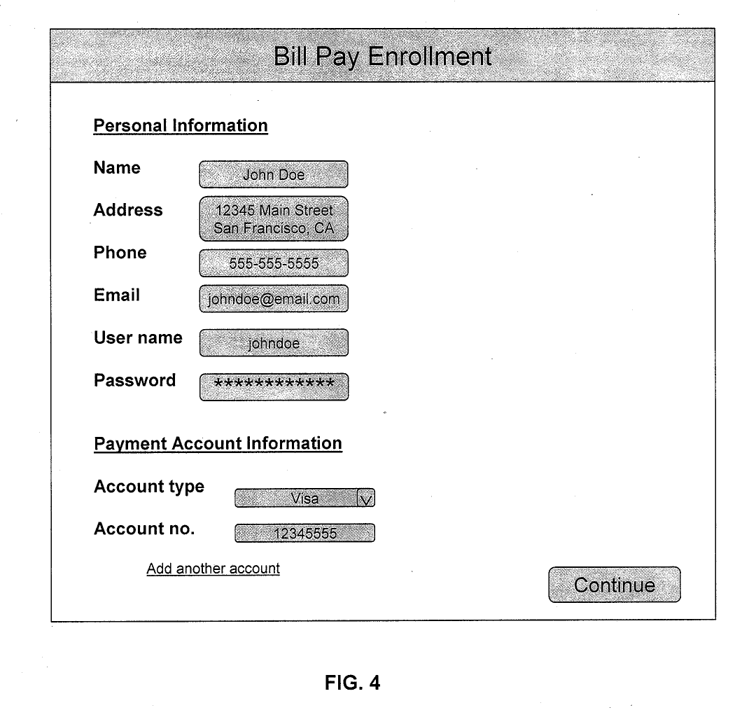

For example, to enroll via a website, the user 10 may access the website via a link or by typing in a particular web address (e.g., www.mybillpay.com). A user 10 may want to pay his Gas & Electric Company bill and may click on a button on the company's website “Bill Pay” as shown in FIG. 9 to access the bill pay system. If the user 10 has not yet been enrolled in the bill pay system, the user 10 may be presented with an electronic enrollment form to be filled out as shown in FIG. 4. Appropriate fields for this form may be provided by the merchant 20, bill pay processing hub 50, merchant processor 60, payment processing network 70, or other appropriate entity. For example, a user 10 may provide a name, address, phone, email, user name and password, and payment account information. The user 10 may have the option to add more than one payment account.

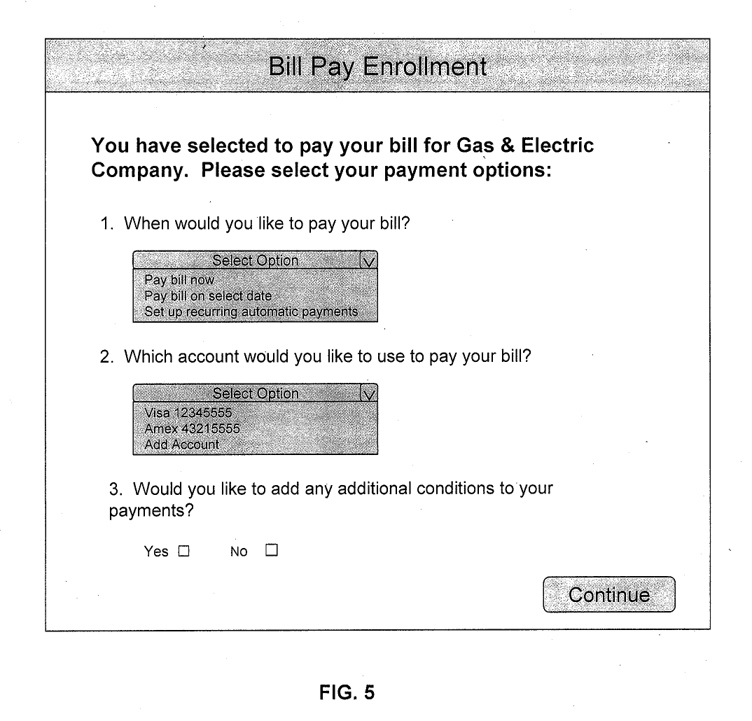

Next the user 10 may be prompted to select payment options. For example, if the user wants to pay his Gas & Electric Company bill, he may be presented with an electronic form as shown in FIG. 5 to select his payment options. For example, the user 10 may select when he would like to pay his bill. He could pay the bill now, pay the bill on a select date, or set up recurring automatic payments. If he chooses to pay on a select date he will be prompted to enter the select date. If he chooses to set up recurring automatic payments he will be prompted to enter the date for the recurring payment (e.g., the 1st of each month, the 25th of each month, 3 days before the bill is due, the date the bill is due, etc.). The user 10 may also be present with payment terms provided by the particular biller (e.g., by Gas & Electric Company).

The user 10 may then select the account to use to pay the bill. The user 10 may choose from a list of accounts already saved in the system or add another account. The user 10 may also have the option to add any additional conditions to his payments. Such conditions may include choosing a specific payment mechanism or account depending upon the amount of the transaction, depending upon the due date of the payment, depending on the credit limit for the account or whether there is enough money in the account for a debit card, or depending on the best way to maximize reward points for a particular account. For example, the user 10 may want to pay the bill with his debit card if the bill is less than $100 but may want to pay the bill with his credit card if the bill is equal to or greater than $100. In another example, a user 10 may want to use a different account if he is already over the credit limit for a particular account or if there is not sufficient money left in an account associated with a debit card. In yet another example, a user 10 may want to pay the bill with his checking account if it is before the 15^{th} of the month but then with his credit card if the bill is after the 15^{th} of the month (e.g., the user 10 may want to time which account is used around when he receives his paycheck).

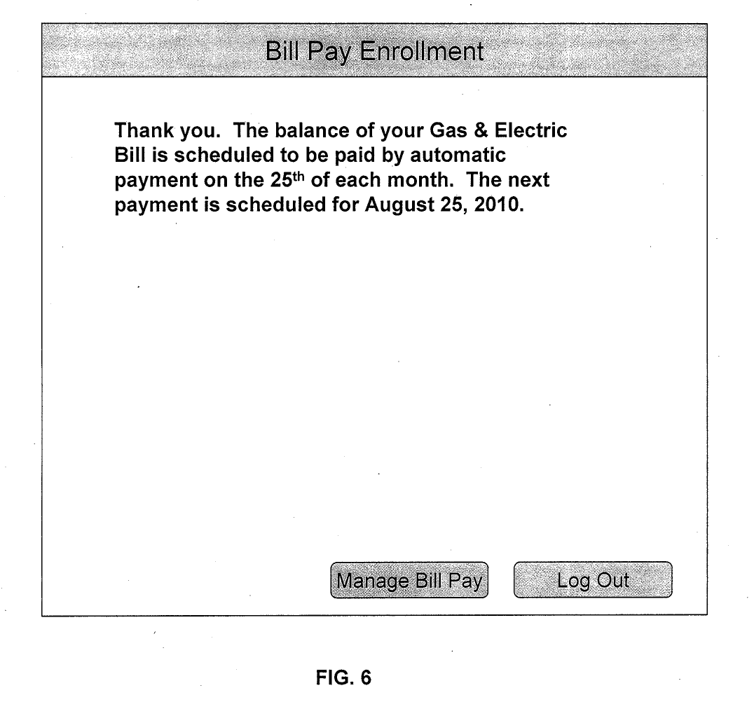

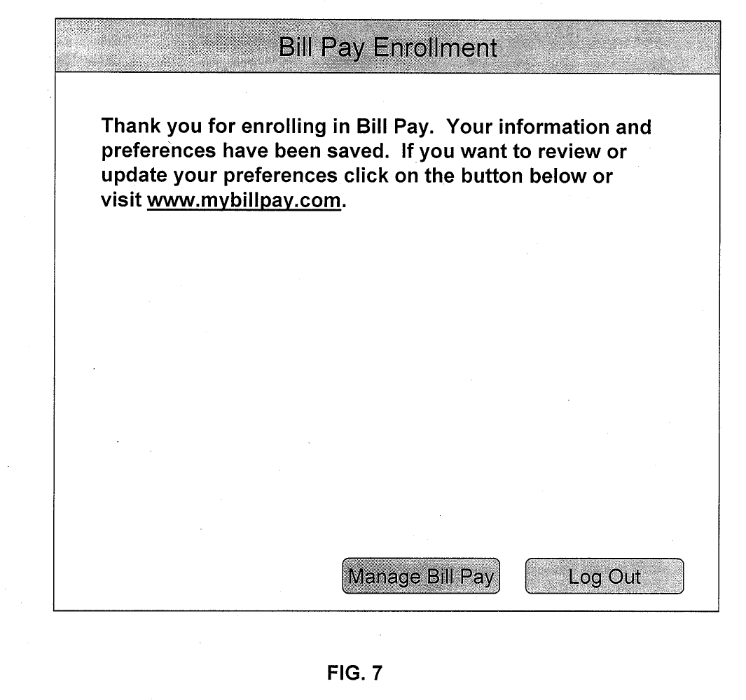

After the user 10 selects payment options, he may be presented with a confirmation message that enrollment has been successful as shown in FIG. 7. Or, if he has provided information about a specific bill, such as payment for his Gas & Electric bill, he may be presented with a confirmation message as shown in FIG. 6.

User enrollment information may be stored at the payment processing network 70 and/or the user preferences database 50(a). For example, the payment processing network 70 may store a list of enrolled users in the bill pay system in a database associated with the payment processing network 70. The user preferences may be stored in the user preferences database 50(a). Alternatively all the enrollment information for the user 10 may be stored in the user preferences database 50(a).

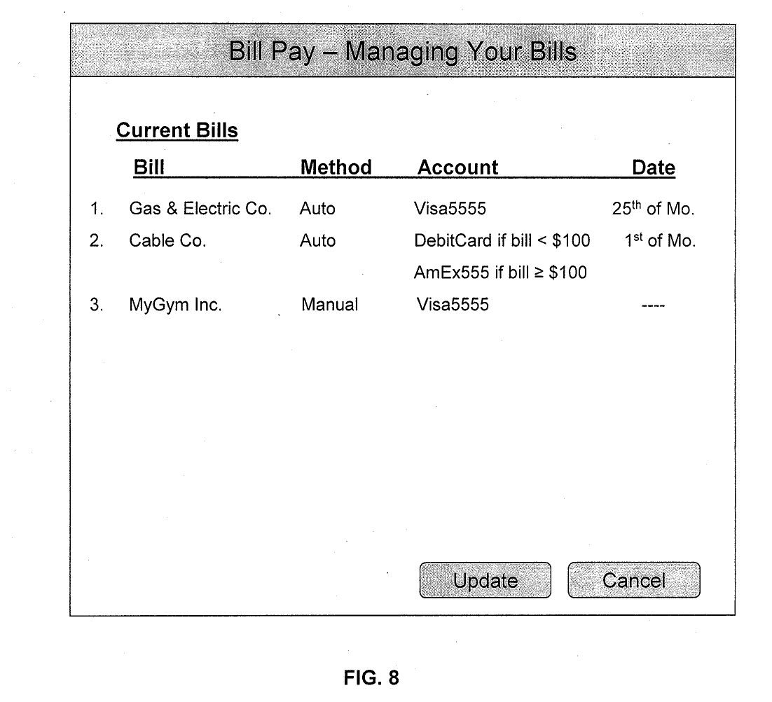

The next time that the user 10 would like to access the bill payment system (e.g., to pay a bill, to update his payment account, to update his payment options, to add a biller, etc.), he may click on a link on the biller website (e.g., as shown in FIG. 9), click on a link accessible from another website or email, or enter a website address (e.g., www.mybillpay.com) into his web browser. The user may then be prompted to enter his user name and password to gain access to his bill pay information. Once he has accessed the bill pay system, he may be able to view his current bills as shown in FIG. 8, update personal information, update payment accounts, update payment options, add bills, etc.

Enrollment in the bill pay service is advantageous to the user 10 because he would only have to enroll once and then he can pay bills with multiple merchants. For example, the user 10 can click a link or button on any participating merchant website, or access the bill pay service add a participating merchant.

Referring back to FIG. 1, value-added consumer-facing features 80 may include a number of turn-key processing features to facilitate the collection and handling of payment card payments from users 10. These features may include web interfaces for the collection of payment of information directly from users, and the ability for users to set up and manage preferences for one-time or automated recurring bill payments. Other features include integration with an account updater service to keep user card information up to date in the event of card re-issue, cancellation or expiration. For example, if a user's payment card expires or is lost, the bill payment system can substitute the expired or lost card number with an updated card number on behalf of the user 10. This can be done in a batch process update to merchants that have the user's payment card information on file, or it could be done real-time during the bill payment transaction to substitute one payment card for the other.

Other features include secure, PCI-compliant storage of user account information. This is advantageous for the user 10 to have more secure account information and more confidence about his transactions through the bill pay system and with the merchant 20. The system may also have notification capabilities for informing users of successful automated payments, for informing users of upcoming payments, etc. For example, a user 10 may receive a message via their mobile device (e.g., SMS via mobile phone), an email, a phone call, a voicemail, etc. A user 10 may also be able to manage his notification preference via the bill payment system.

The features described above may be encompassed into a central platform to build a variety of customer facing features that can be reused across multiple payment cardholders, card issuers, and merchants using the bill pay processing hub model.

Bill Payment

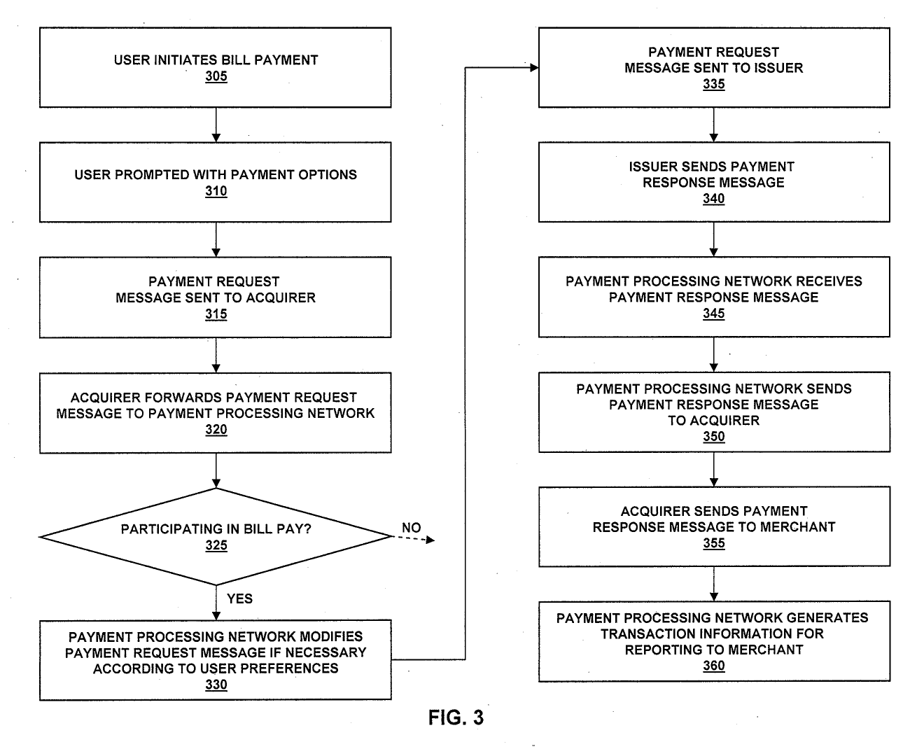

FIG. 3 shows a flowchart including a general method according to an embodiment of the invention. The method can be described with reference to the block diagram in FIG. 1.

First, a user 10 initiates bill payment (step 305). A user 10 may receive a notification message via SMS, email, or other method as described above. The notification message may be a reminder that a bill payment is due and have some details on the currently set preferred method of payment (e.g., an indication of the account number (e.g., last 4 digits, or an alias for the account and timing for payment) and timing for payment). The user 10 may click on a link in the message if applicable to initiate the payment or, as explained above, the user 10 may go to the biller's website and click a link or a button to pay his bill, or may go directly to the bill pay system by typing in a website address in his web browser. FIG. 9 shows an exemplary screen shot of a user interface for a Gas & Electric Company website that has a “Bill Pay” button. Once the user 10 clicks the “Bill Pay” button he is prompted with payment options as described earlier and shown in FIG. 5 if the user 10 has not yet set up payment options for the bill or wants to modify the payment options. If the user 10 has already set up payment options for the bill, he may see a message with the details of his preferred method of payment and he can just select “continue” to use the same preferences. Once the user 10 confirms his payment options, a payment request message is generated by the merchant biller 20.

If the user 10 has already set up his payment options to have the bill paid by recurring automatic payment or on a specific date, a payment request message may be generated automatically by the merchant biller 20 on the specified date without any user interaction. A payment request message may include information such as the transaction amount, card verification value, service code, expiration date, merchant category code, portable consumer device identifier (e.g., an account number, alias, or other identifier), and other information. If the merchant biller 20 is relying upon another entity such as the bill pay processing hub 50, the payment processing network 70, or the merchant processor 60 to securely store the user account information, the payment request message may not contain account information (e.g., account number) or may just include a placeholder for such information.

The payment request message is then sent to the acquirer 30 (step 315). The acquirer 30 forwards the payment request message to the payment processing network 70 (step 320). The payment processing network then determines whether the user 10 associated with the payment request message is enrolled in the bill pay service (step 325). For example, the payment processing network may check the user's account information to see if he is enrolled in the bill pay service (e.g., the account may have a flag in a field indicating enrollment). If the user 10 is enrolled in the bill pay service, the payment processing network 70 may next check a user preferences database 50(a) to determine whether the user's preferences in the database are different from the information included in the payment request message. For example, a user 10 may have updated his preferences to include a new account number that he prefers to use for that particular bill, or may have conditions around which account should be used depending on the total amount of the bill (e.g., use debit card if bill less than $100, use credit card if bill greater than or equal to $100). Or, the bill processing hub 50, merchant processor 60, or payment processing network 70 may be storing the account information on behalf of the merchant and thus the payment request message may not have an account number or may have just a place holder for the account number. If necessary, the payment processing network modifies the payment request message according to the user preferences. The payment request message is then sent to the issuer 40.

After the issuer 40 receives the payment request message, the issuer 40 sends a payment response message back to the payment processing network 70 to indicate whether or not the current transaction is authorized. The payment processing network 70 then forwards the payment response message back to the acquirer 30. The acquirer 30 then sends the response message back to the merchant 20.

A user 10 may receive notification that payment of his bill has been made. For example, a user 10 may receive a message via his mobile phone (e.g., an SMS message), an email, voicemail, or other specified or automatic notification.

The payment processing network 70 then generates transaction information for reporting to the merchant. As described above, reporting to the merchant 20 can take different forms. For example, on a regular basis (e.g., daily, weekly, monthly) a full report may be sent from the bill pay processing hub 50 to the merchant. The report includes the transaction information generated by the payment processing network 70 for any bills processed related to the bill pay system, and is combined with any existing reporting and billing processes for the biller. For example, the report may include other payment information such as traditional ACH payments, as explained above. This could be in batch files. In the alternative, a merchant 20 may desire individual emails or faxes when payments are received (e.g., a small merchant may not have many transactions and thus may want more frequent reporting).

Transaction information may also be aggregated with other transaction data and used for marketing, competitive benchmarking, or financial management. The payment processing network 70 may provide this information to the merchant 20 in the full report sent to the merchant 20 or via a separate report, or the payment processing network 70 may provide this information in the form of a tool that the merchant 20 can use to search for specific information or to generate its own reports depending on the information desired.

As explained above, embodiments of the invention provide a number of technical advantages such as a faster and simpler technical implementation for a bill pay solution, more secure payments and account information, a more flexible implementation for adding and removing features of the system, and a faster processing of payments made with payment cards. In particular, advantages to the merchant include the ability to receive a consolidated report that combines traditional payment data with payment card payments and reconciliation data, ease of implementation and reduced costs to accept payment cards, new acceptance segments for payments cards, resulting in increased volumes and revenues. For example, by making it easier for users to sign up and manage their payment relationships with billers, merchants may see more business benefits by getting more sales and having more satisfied customers. This ease of use may also result in more timely payments from users of the system. Moreover, the merchant has the flexibility to add or remove various features at any time with little to no implementation on its part. For example, a merchant may rely on the bill payment system to store sensitive account information on its behalf and thus, be provided more security for sensitive information. Merchant features and associated benefits are described in further detail above.

Advantages to the user include ease of control over and management of bill payment options. For example, if a user sets up a several bills for automatic recurring payments using a particular card and the card expires or the user wants to change which card is used for payment, the user only has to update the payment card information once instead of contacting each and every biller to update this information. Similarly, a user can easily stop recurring payments without having to call a merchant or issuer to do so. In addition, users can receive notification of bill payments according their preferences. User features and associated benefits are described in further detail above.

Benefits to the issuer, payment processing network, or merchant processor include increased usage of payment cards and the ability to charge fees for various features and services. Moreover, if a user chooses to make a payment with a payment card instead of traditional payment methods, the payment is typically processed immediately, versus traditional payment methods which my take a day or two to process. An additional fee may be charged by the merchants to offer this service, if desired. This would be additionally beneficial to the user if he is paying a bill last minute so that timely payment of the bill can still occur.

Embodiments of the invention described herein can be extended to general ecommerce or mobile applications. One enrollment by a consumer would allow him to manage his ongoing bill payments and also provide him with registration for easier single click or single touch payment setup on other participating merchant websites or mobile applications.

Computer System

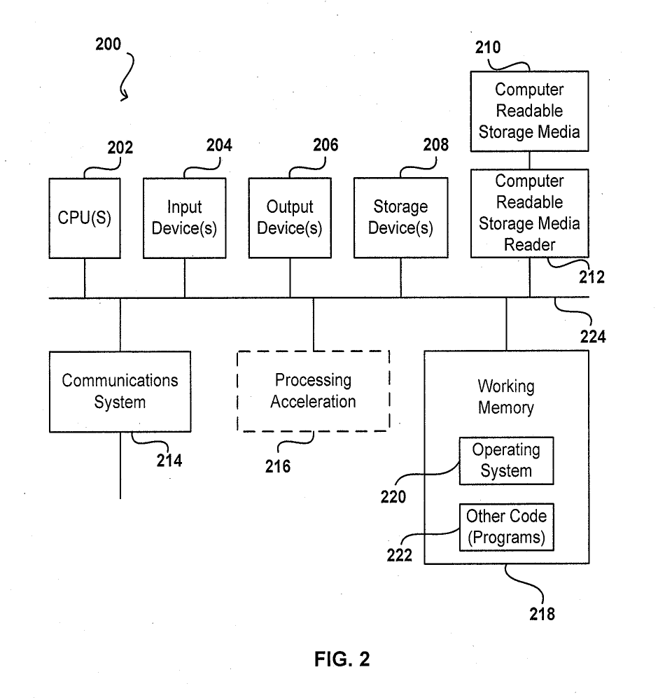

FIG. 2 illustrates an exemplary computer system 200, in which various embodiments may be implemented. The system 200 may be used to implement any of the computer systems described above (e.g., a server computer at the merchant processor, payment processing network, bill pay processing hub, acquirer, issuer, merchant, etc.). The computer system 200 is shown comprising hardware elements that may be electrically coupled via a bus 224. The hardware elements may include one or more central processing units (CPUs) 202, one or more input devices 204 (e.g., a mouse, a keyboard, etc.), and one or more output devices 206 (e.g., a display device, a printer, etc.). The computer system 200 may also include one or more storage devices 208. By way of example, the storage device(s) 208 can include devices such as disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 212, a communications system 214 (e.g., a modem, a network card (wireless or wired), an infra-red communication device, etc.), and working memory 218, which may include RAM and ROM devices as described above. In some embodiments, the computer system 200 may also include a processing acceleration unit 216, which can include a digital signal processor DSP, a special-purpose processor, and/or the like.

The computer-readable storage media reader 212 can further be connected to a computer-readable storage medium 210, together (and, optionally, in combination with storage device(s) 208) comprehensively representing remote, local, fixed, and/or removable storage devices plus storage media for temporarily and/or more permanently containing, storing, transmitting, and retrieving computer-readable information. The communications system 214 may permit data to be exchanged with the network and/or any other computer described above with respect to the system 200.

The computer system 200 may also comprise software elements, shown as being currently located within a working memory 218, including an operating system 220 and/or other code 222, such as an application program (which may be a client application, Web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method comprising:
receiving a payment request message that includes information related to a user and a biller;
determining whether the user is enrolled in a bill pay program;
if the user is enrolled in the bill pay program, modifying the payment request message according to user preferences if the user preferences are different than the information in the payment request message;
receiving a payment response message; and
generating, using a server computer, transaction information based on the payment response message and biller information, wherein the transaction information is combined with existing reporting and billing process information for the biller.

2. The method of claim 1 wherein the information related to the user includes a portable consumer device identifier.

3. The method of claim 2 wherein the portable consumer device identifier is an account number or alias.

4. The method of claim 1 wherein user preferences include at least one preferred payment method and conditions for payment.

5. The method of claim 1 wherein the payment request message includes a portable consumer device identifier and modifying the payment request message includes substituting the portable consumer device identifier with a second portable consumer device identifier.

6. The method of claim 1 wherein the transaction information is aggregated with other transaction data and used for marketing, competitive benchmarking, or financial management.

7. The method of claim 1 further comprising:
providing tools for the biller to manage its reporting and billing processes.

8. The method of claim 1 further comprising:
providing tools for the user to manage user preferences.

9. The method of claim 1 wherein the transaction information includes information for transactions associated with portable consumer devices, and wherein the transaction information is combined with non-portable consumer device transaction data and provided to the biller through existing reporting and billing process information for the biller.

10. The method of claim 1 wherein the server computer resides at a payment processing network.

11. The method of claim 1 further comprising:
sending to the user, notification associated with the bill payment transaction.

12. The method of claim 1 wherein the notification is sent to a mobile phone associated with the user.

13. The method of claim 1 wherein existing reporting and billing processing information for the biller includes one or more of Automated Clearing House transactions, Electronic Fund Transfers, EDI, and paper items processing.

14. A computer readable medium comprising:
a computer readable program code embodied therein, the computer readable program code adapted to be executed by a processor to implement the method of claim 1.

15. A server computer comprising:
a processor; and
the computer readable medium of claim 14 coupled to the processor.

16. A method comprising:
providing, using a computer apparatus, user information; and
providing preferences related to bill payment wherein the user information and preferences related to bill payment can be utilized to pay bills from different merchants.

17. The method of claim 16 further comprising:
initiating a bill payment transaction associated with a user enrolled in a bill pay program wherein a payment request message is subsequently received at a server computer that includes information related to the user and a biller, and wherein the payment request message is modified according to user preferences if the user preferences are different than the information in the payment request message and wherein a payment response message is received and transaction information is generated based on the payment response message and biller information, wherein the transaction information is combined with existing reporting and billing processes for the biller.

18. The method of claim 16 wherein user information includes a portable consumer device identifier.

19. The method of claim 18 wherein the portable consumer device identifier is an account number or alias.

20. The method of claim 16 wherein preferences include at least one preferred payment method and conditions for payment.

21. The method of claim 16 further comprising:
receiving notification associated with the bill payment transaction.
